(19) United States
(12) Patent Application Publication
(10) Pub. No.: US 2017/0152619 A1
(43) Pub. Date: Jun. 1, 2017

(54) MAT FOR FORMING AN ARTIFICIAL LAWN AND PROCESS FOR PRODUCING SUCH A MAT

(71) Applicant: BFS Europe NV, Kruishoutem (BE)

(72) Inventors: Mathijs Beauprez, Sint-Amandsberg (BE); Kjell De Rudder, Erembodegem (BE); Frank Vancoillie, Wielsbeke (BE); Marc Verleyen, Hulste (BE)

(73) Assignee: BFS Europe NV, Kruishoutem (BE)

(21) Appl. No.: 15/308,756

(22) PCT Filed: Jun. 2, 2015
(86) PCT No.: PCT/EP2015/062278

§ 371 Date: Nov. 3, 2016

(30) Foreign Application Priority Data
Jun. 2, 2014 (EP) 14170811.5

(51) Int. Cl. D05C 17/02; D01D 5/088; E01C 13/08; B32B 5/26; B32B 5/24; D05C 15/04; B32B 5/02

(52) U.S. Cl. CPC D05C 17/023; D05C 15/04; D01D 5/0885; B32B 5/028; B32B 5/26; B32B 5/245; E01C 13/08; D10B 2505/18; B32B 2307/56

(57) ABSTRACT

A new mat (1, 101), for forming an artificial lawn (9), in particular an artificial grass sports field, is disclosed whereby the mat (1, 101), comprises a cushioning layer (5, 105) and artificial fibers (4, 104) tufted through this cushioning layer (5, 105). With this new mat (1, 101) construction, the artificial lawn (9) also comprising an infill material (8), has improved shock absorption characteristics.

### FIELD OF THE INVENTION

The present invention relates to a mat for forming an artificial lawn, to a process for making the mat, and to artificial lawn.

### BACKGROUND OF THE INVENTION

For the purpose of the further description, with artificial lawn it is meant a lawn with artificial fibers representing grass and which may be used for one or more activity such as sport, training or which even can be adapted for a particular activity or leisure. Often infills such as sand or granules are used in combination with artificial lawn to provide a softer, damping and thus less injury-prone playing surface and this also leads to better playing characteristics. Pure esthetically, in general an artificial lawn with an infill resembles much more a natural grass field than without infill. Furthermore, when using an infill for forming an artificial lawn, the artificial fibers are better maintained in an upright position, due to the dense structure of the filler material.

According to the art, e.g. US20040229007, an infilled artificial surface can resemble natural grass-like play characteristics due to the use of distinct groups of fibers with different heights extending upwardly from a backing, and stabilizing infill material residing on the backing. One group of grass-like fibers have a height extending from the backing to above the infilled area and another group of fibers have a height extending from the backing but not above the infilled area.

Referring e.g. to FIFA requirements, as detailed in the FIFA Quality Concept Handbook of Test Methods for Football Turf (January 2012 Edition), a guidance for assessing the ball surface interaction, player surface interaction and durability of product, necessary measures need to ensure that sufficient energy absorption happens when touching the artificial lawn. More in particular this energy absorption is not only of importance at the place directly underneath the place of touching the lawn, but also in a local area around that place. The required absorption may be defined for the particular purpose or activity for which the artificial lawn is intended for, like for instance playing football. In this respect it is noted that when sports are practiced onto artificial lawns from the art, players are typically much faster and more easily getting tired, due to the so-called restitution of the lawn, which is the negative result of the absorption characteristics.

### AIM OF THE INVENTION

The invention aims at providing a mat for an artificial lawn, such as a grass sports field, with improved playing and field characteristics.

### SUMMARY OF THE INVENTION

According to a first aspect of the invention a mat is provided, for forming an artificial lawn, comprising a cushioning layer and artificial fibers, characterized in that the artificial fibers are attached to the cushioning layer by means of tufting techniques.

According to a second aspect of the invention, an artificial lawn is provided, preferably a sports field, comprising a mat according to the first aspect of the invention and an infill material.

In a preferred embodiment, the cushioning layer comprises a substrate and an open web of inter-engaged continuously, crinkled filaments of polymeric material, having resilient characteristics and forming an integrated structure.

According to a third aspect of the invention, a process for producing a mat according to the first aspect of the invention is provided, comprising the steps of providing a cushioning layer and tufting artificial fibers through the cushioning layer, forming a tufted structure.

### DRAWINGS

FIG. 1 shows an embodiment of a mat for forming an artificial lawn in accordance with the present invention.

FIG. 2 shows another exemplary embodiment of a mat for forming an artificial lawn in accordance with the present invention.

FIG. 3 shows an embodiment of an artificial lawn in accordance with the present invention.

FIG. 4 shows another exemplary embodiment of an artificial lawn in accordance with the present invention.

FIG. 5 illustrates schematically an embodiment of the process for producing a mat for forming an artificial lawn in accordance with the present invention.

### DETAILED DESCRIPTION OF THE INVENTION

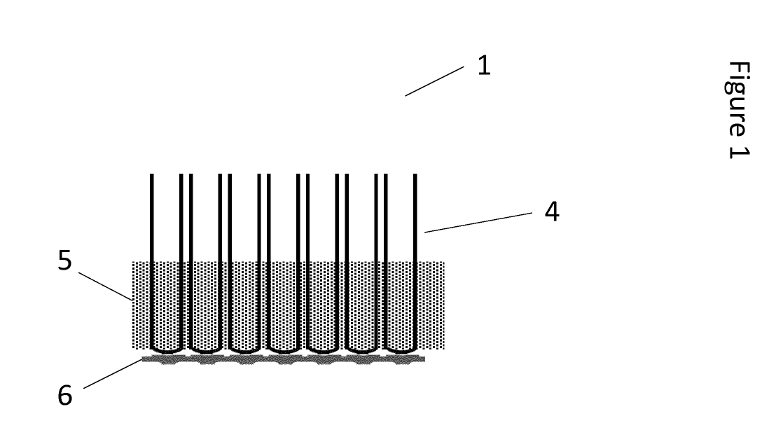

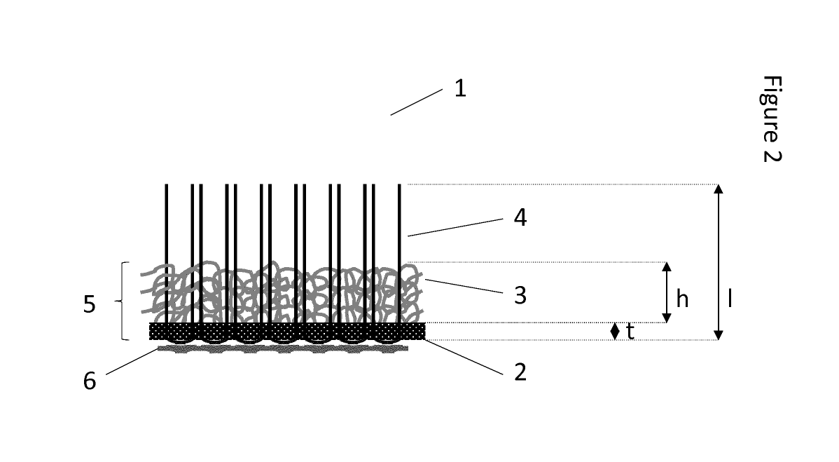

FIG. 1 illustrates a mat 1 for forming an artificial lawn 9 according to the present invention. There are no particular restrictions on the dimensions of the mat 1, and which are dependent on the desired application. The mat 1 comprises a cushioning layer 5 and artificial fibers 4. The artificial fibers 4 are attached to the cushioning layer 5 by means of tufting techniques. The cushioning layer 5 serves as a carrier or primary backing, and moreover provides shock-absorbing properties like a shock pad. The cushioning layer 5 can be made for instance of resilient foam or of expanded structures made of polymeric material, or of extruded filaments in an open web. The artificial fibers 4 are e.g. synthetic grass fibers, and are preferably made of LLDPE (linear low density polyethylene), but may also be made in other PE variants, as well as e.g. polypropylene, polyester or nylon. Particularly for the application of an artificial grass sports field, the artificial fibers 4 of the mat 1 are artificial grass fibers. However in the case of leisure, playmats, anti-fatigue mats or other sports fields, the artificial fibers 4 may represent another type of natural or decorative effect.

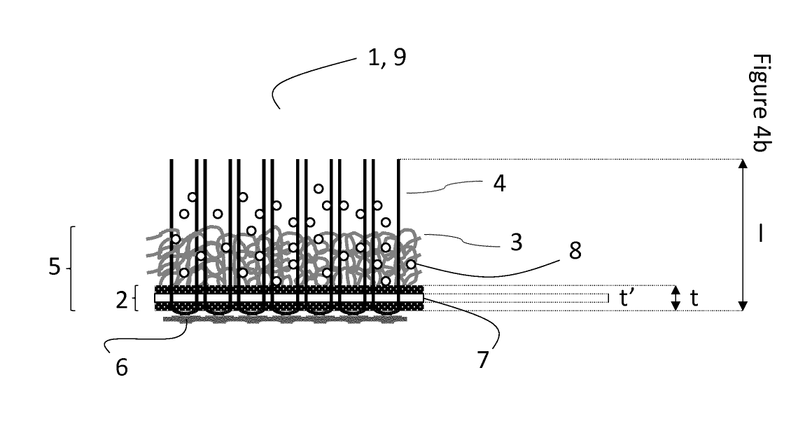

The mat 1 for forming an artificial lawn 9 may further comprise an additional layer, such as a secondary backing layer 6 (as shown in FIG. 1, 2) or a reinforcing layer 7 (as shown in FIG. 4a, 4b) underneath the cushioning layer 5, in order to protect the tufted fibers or to enhance (e.g. strengthening) the mat construction.

The secondary backing layer 6 can be made of PE powder or glue, PVC or could be for example an extrusion coating, or can be fabricated according to calander thermo processing. The reinforcing layer 7, provided underneath or within the cushioning layer 5 (as depicted in FIG. 4a, 4b) will provide dimensional stability to the mat 1. The reinforcing layer 7 can be a woven or a non-woven (e.g. needle felt, spunbond, or glass fiber) fabric. The reinforcing layer has a thickness t′ between 0.1 mm and 3 mm, preferably between 0.2 mm and 1.5 mm, more preferably between 0.5 mm and 1 mm.

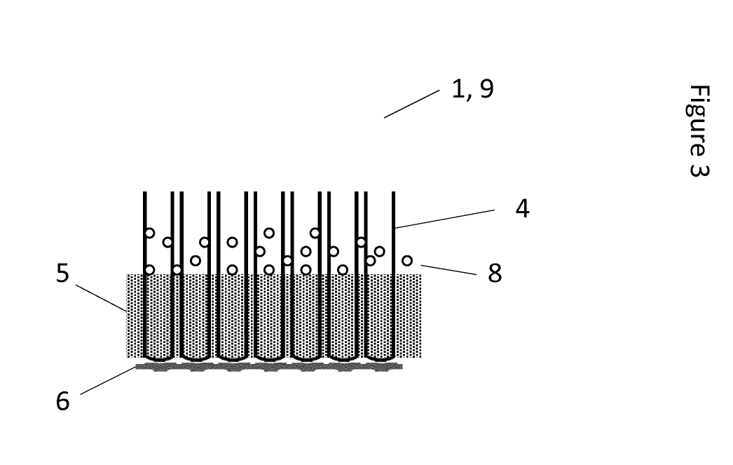

In FIG. 2, a preferred embodiment of the mat 1 is shown. The cushioning layer 5 of the mat 1 comprises a substrate 2 as a lower layer, onto which a lofty open web of inter-engaged continuously crinkled filaments 3 is provided, i.e. the filaments 3 are crinkled and are applied onto the substrate 2 as a continuous spaghetti-like structure. These filaments 3 are preferably attached to the substrate 2 by means of glueing and/or melting together part of the filaments 3 at some or all points of mutual contact with the substrate 2. Both the substrate 2 and the filaments 3 on top, forming together an integrated structure are typically made of resilient polymeric material, such as e.g. thermoplastic polymeric material. With resilient polymeric material it is meant a material particularly having resilient characteristics, i.e. having the ability of returning to an original shape or position after compression. They can be made of polyvinyl chloride (PVC), PE, PP, polyamide (PA), ethylene propylene diene monomer (EPDM) or any other suitable polymeric material. The artificial fibers 4 are tufted through the substrate 2 and extending therefrom and above the open web.

According to the invention, the substrate 2 as depicted in FIG. 2 is an extruded layer (possibly foamed) of e.g. PVC or polyolefin, PE, PP, PA, EPDM, or any other suitable polymeric material, preferably resembling a thick plastic flexible structure, and having a thickness t. The thickness t can vary between 0.5 mm and 10 mm, preferably between 0.5 mm and 5 mm, more preferably between 1 mm and 4 mm. The lofty open web of filaments 3 has a height h above the substrate. of between 3 mm and 40 mm, preferably between 5 mm and 20 mm, more preferably between 7 mm and 15 mm, and most preferably between 13 mm and 15 mm.

The linear mass density, i.e. the mass in grams per 10000 m, of one artificial fiber 4, is between 400 dtex (decitex) and 6000 dtex, preferably between 1000 dtex and 4500 dtex, and most preferably between 1600 dtex and 2500 dtex. The length I of the tufted cut piles of the artificial fibers 4 is generally between 10 mm and 80 mm, preferably between 30 mm and 70 mm, more preferably between 40 mm and 60 mm.

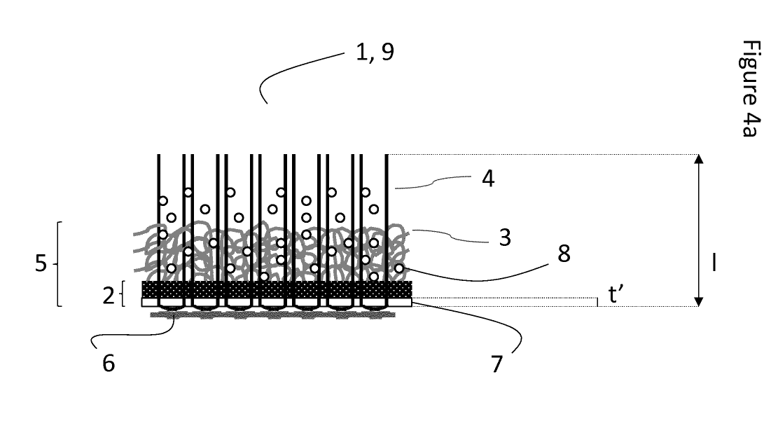

When the mat 1 of the present invention is used as an artificial lawn 9, in particular a grass sports field an infill material 8 is added in-between the artificial fibers 4 onto the cushioning layer 5 as shown in FIG. 3.

According to another embodiment, depicted in FIG. 4a and FIG. 4b, in the artificial lawn 9, comprising a mat 1 with a cushioning layer 5 comprising a substrate 2 and the lofty open web of filaments, an infill material 8 is dispersed throughout the open web, and preferably also partially in-between the artificial fibers 4.

Due to the integrated structure of open web filaments 3 with the substrate 2, much less infill 8 is required compared to other artificial lawns of the art. Less than 50%, even less than 35% of the typical amount of infills used in artificial lawns of the art is possible. In one embodiment, the artificial lawn comprises less than 15 kg/m², preferably less than 10 kg/m², more preferably less than 8 kg/m², even more preferably less than 6 kg/m² of infill. In some embodiments of the present invention, the use of an infill 8 can even be omitted. With the integrated structure comprising the substrate 2 and the filaments 3, into which the infill 8 is incorporated in a limited amount, the infill 8 will eventually become denser over time to a lesser extent compared to artificial lawns of the art. Hence the quality of the artificial lawn comprising a mat 1 according to the present invention is far better compared to those of the art.

The infill material 8 can for instance be made of plastic, rubber material, or organic material such as cork or coco. In a preferred embodiment hollow infill materials may be used, e.g. the polymer granules referred to in WO2009/118388. The infill materials 8 are preferably not sand. Sand may have a negative effect because of its clogging effect due to environmental/weather conditions after a while.

The mat 1 according to the present invention represents a specific energy absorption, through which a certain damping or bouncing effect is generated. Particularly for sports applications, this leads to mats with improved playing characteristics compared to the art. Moreover, people can also benefit of this effect for other applications. In an environment e.g. where people need to walk frequently or intensively, the mat according to the present invention can typically function as anti-fatigue mat.

According to an embodiment of the present invention, the mat 1 is provided with a further shockpad, determined as a shock-absorbing layer, beneath the tufted structure.

In one preferred embodiment, the artificial lawn 9 according to the present invention has a force reduction (FR) in the range of 40% to 90%, preferably in the range of 55% to 70%, more preferably in the range of 60% to 70%.

In another preferred embodiment, the artificial lawn 9 according to the present invention has a vertical deformation (VD) in the range of 4-11 mm, preferably in the range of 4-10 mm, more preferably in the range of 4-9 mm, even more preferably in the range of 4-8 mm.

In yet another preferred embodiment, the artificial lawn 9 according to the present invention has an energy restitution (ER) in the range of 10% to 80%, preferably in the range of 20% to 40%, and more preferably in the range of 20% to 30%.

In a highly preferred embodiment, the artificial lawn of the present invention possesses a combination of at least 2 of the foregoing parameters (i.e. at least 2 of FR, VD, and ER), and in the most preferred embodiment, the artificial lawn meets all 3 parameters (i.e. FR, VD and ER). The artificial mat, according to the most preferred embodiment, thus has:
a force reduction (FR) in the range of 40% to 90%, preferably in the range of 55% to 70%, more preferably in the range of 60% to 70%; and
a vertical deformation (VD) in the range of 4-11 mm, preferably in the range of 4-10 mm, more preferably in the range of 4-9 mm, even more preferably in the range of 4-8 mm; and
an energy restitution (ER) in the range of 10% to 80%, preferably in the range of 20% to 40%, and more preferably in the range of 20% to 30%.

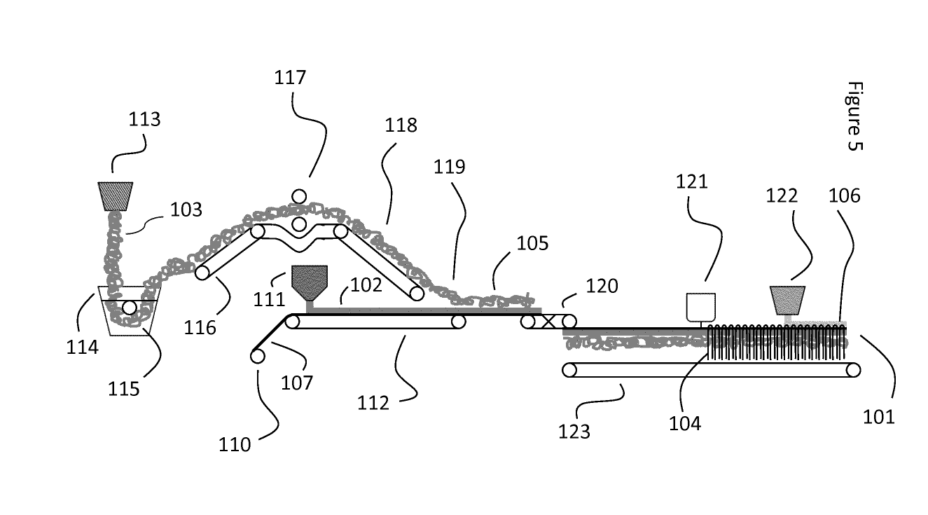

According to the invention, a process for producing a mat 1 is also provided, comprising the steps of (i) providing a cushioning layer 5 and (ii) tufting artificial fibers 4 through this cushioning layer 5, forming a tufted structure. In an embodiment of the invention, the cushioning layer 5 comprises a substrate 2 and an open web of inter-engaged continuously, crinkled filaments 3, wherein the artificial fibers 4 are tufted through the substrate 2 and through the open web. FIG. 5 illustrates schematically the production process for a mat 1, 101 in accordance with this particular embodiment.

Shown in FIG. 5, is a process scheme for manufacturing a mat 1, 101 for forming an artificial lawn 9 in accordance with the present invention. More in particular, the mat 1, 101 comprises a cushioning layer 5, 105 with a substrate 2, 102 and an open web. Starting with a roller 110 from which a reinforcing layer 7, 107 is unwound, a line 112 is consecutively arranged during which a substrate 2, 102 is provided. The substrate 2, 102 in fluid state, delivered from the tank 111, is directly applied onto the reinforcing layer 7, 107, for the line 112 being active. Further, an extruder tank 113 is part of the production set-up, out of which loose filaments 3, 103 are extruded and lead to a bath 114 filled with water 115 in order to cool down the extruded filaments 3, 103. As soon as the filaments 3, 103 are guided out of the water bath 114, a next line 116 is followed transporting them to another stage 117 where the filaments 3, 103 are provided with an adhesive. The filaments 3, 103 with loose ends are now fixed or glued together with for example PVC, such that a continuous crinkled chain is formed, and as a result a better constitution is achieved for energy absorption. The filaments chain is then further transported via the line 118 down to further stage 119 where filaments 3, 103 and substrate 2, 102, provided with reinforcing layer 7, 107, are brought together and where part of the filaments 3, 103 are bonded, melted and/or welded at some or all points of mutual contact with the substrate 2, 102. Further continuing the process now with the cushioning layer or primary backing 5, 105 being finished, at consecutive stage 120 the entire primary backing 5, 105 formed is now turned upside down in order to achieve the appropriate orientation for tufting the primary backing 5, 105. The reinforcing layer 7, 107, being provided onto the substrate 2, 102, is now op top, facing the tufting equipment 121, as the primary backing 5, 105 is further propagated. Besides the tufting equipment 121, by means of which artificial fibers 4, 104 are attached, the line 123 is subsequently provided with a tank 122, ejaculating a backing layer or secondary backing 6, 106, being applied onto the tufted structure and thereby loop pile bonding the tufted structure. At the end of the line 123, the production of the mat 1, 101 is accomplished.

In addition to the example of a football field as a grass sports field, other kinds of playing fields applicable to the present invention can be e.g. hockey fields, rugby pitches, polo, American/Australian football, golf, baseball, ski and snowboard, tennis courts, landscaping, including any other indoor as well outdoor sports field.

Moreover, playgrounds or leisure fields are also mentioned as an example.

Experiment Related to FIFA Requirements

According to the January 2012 Edition of the FIFA Quality Concept Test Method Manual, a new methodology for the measurement of respectively force reduction—as determination of shock absorption, vertical deformation and energy restitution, has been presented in accordance with the so-called Triple A test, also known as the Advanced Artificial Athlete. The Triple A test method allows to measure force reduction, vertical deformation and energy restitution.

It is also noted that the FIFA Quality Concept has introduced two categories of performance. FIFA Recommended Two Star, further referred to as FIFA**, is the professional category and has been established to ensure fields meeting it, replicate the playing qualities of the best quality natural turf pitches. This category is intended for official games and competition matches. The FIFA Recommended One Star category, further referred to as FIFA*, has slightly wider bands of acceptability and is rather aimed at training and community use.

The FIFA Quality Concept laboratory test program concerns a program of simulated use to assess the ability of a surface to perform for a period of time.

The FIFA test method for the determination of shock absorption includes a set-up, wherein a mass of 20 kg, having a spring with 70 mm diameter mounted to its lower side, is dropped from a 55 mm height onto an artificial lawn placed above a concrete floor. As mentioned in the January 2012 Edition of the FIFA Quality Concept Handbook, the force reduction expressed as a percentage, is determined as follows. From the recorded acceleration of the mass from the moment of release till after its impact with the artificial lawn, the force reduction is calculated by comparing the percentage reduction in this force relative to a reference force (theoretical force on concrete, without artificial lawn). A higher percentage of force reduction means that the artificial lawn performs more shock absorption.

In ideal conditions, natural turf produces a force reduction of between 60 and 70%. Hence, the force reduction in the shock absorption test for a FIFA** qualification for an artificial lawn has to be in the range of 60 to 70%. On the other hand, the force reduction has to be in the range of 55 to 70% for obtaining a FIFA* qualification.

The energy restitution being a measure for the energy returned by the artificial lawn (or natural turf), can also be calculated out of the Triple A test. The energy restitution is e.g. aimed at 20-50%, or else 20-40% for stricter qualification. In comparison, generally, natural turf has an energy restitution of 20-30%.

As a final measure related to the Triple A test, the vertical deformation is herewith considered, being in the range of 4-11 mm for a FIFA* qualification, and in the range of 4-10 mm for a FIFA** qualification for an artificial lawn.

### TEST EXAMPLE

Conforming the above Triple A test regarding FIFA* and FIFA** qualification for an artificial lawn in accordance with the present invention, has been measured.

In a first step a mat without any infill dispersed into it was tested, and corresponding shock absorption was measured, in 2 different positions, in point A and B respectively, and for 3 different impacts (N=1, 2, 3).

The mat is made of a foamed PVC substrate with a thickness of 3 mm, attached thereto an open web of filaments with a thickness of 12 mm. The filaments have a diameter of about 0.5 mm on average. Fibers of 5200 dtex are tufted through the substrate and the open web of filaments with a total height of about 45 mm.

Table 1 represents the values for the vertical deformation (VD) in mm, the force reduction (FR) in %, as well as the energy restitution (ER) in % as calculated for the test.

TABLE 1
A mat (without infill)

| Point | N | VD (mm) | FR (%) | ER (%) |
|---|---|---|---|---|
| A | 1 | 8.08 | 55.7 | 22.9 |
| A | 2 | 8.09 | 51.9 | 27.6 |
| A | 3 | 7.32 | 47.0 | 33.2 |
| MA | | 7.70 | 49.5 | 30.4 |
| B | 1 | 9.57 | 58.3 | 19.7 |
| B | 2 | 8.57 | 52.8 | 26.2 |
| B | 3 | 7.89 | 48.8 | 30.9 |
| MB | | 7.71 | 50.8 | 30.4 |
| FIFA* | | 4-11 | 55-70 | — |
| FIFA** | | 4-10 | 60-70 | — |

Next, the same mat provided with an infill was tested, and corresponding shock absorption was measured, again in 2 different positions, in point A and B respectively, and for 3 different impacts (N=1, 2, 3). The infill are rubber granules, dispersed for a layer of 10 mm and from the type Holo SP TPE of 5kg/m². Table 2 represents the values for the vertical deformation (VD) in mm, the force reduction (FR) in %, as well as the energy restitution (ER) in % as calculated for the test.

TABLE 2
A mat with infill, being a 10 mm Holo SP TPE (rubber granules)
layer of 5 kg/m²

| Point | N | VD (mm) | FR (%) | ER (%) |
|---|---|---|---|---|
| A | 1 | 9.89 | 62.9 | 22.2 |
| A | 2 | 8.94 | 59.0 | 25.5 |
| A | 3 | 9.24 | 58.5 | 27.8 |
| MA | | 9.09 | 58.8 | 26.6 |
| B | 1 | 9.00 | 62.5 | 24.4 |
| B | 2 | 10.12 | 63.5 | 24.2 |
| B | 3 | 9.86 | 61.9 | 26.3 |
| MB | | 9.99 | 62.7 | 25.3 |
| FIFA* | | 4-11 | 55-70 | — |
| FIFA** | | 4-10 | 60-70 | — |

As a conclusion, it can be clearly stated that the artificial lawn according to the present invention, comprising a mat with an infill of rubber granules, satisfies the FIFA* and/or FIFA** qualification requirements for an artificial lawn.

1. A mat for forming an artificial lawn comprising a cushioning layer; and artificial fibers; wherein said artificial fibers are attached to said cushioning layer by tufting techniques.

2. The mat of claim 1, wherein said cushioning layer is made of resilient foam, expanded structures, or extruded fabrics made of polymeric material.

3. The mat according to claim 1, further comprising a reinforcing layer and/or a backing layer.

4. The mat according to claim 1, wherein said cushioning layer comprises a substrate and an open web of inter-engaged continuously, crinkled filaments of resilient polymeric material forming an integrated structure.

5. The mat of claim 4, wherein said artificial fibers extend from said substrate through and above said open web.

6. The mat according to claim 4, wherein at least a portion of said open web is adherently bonded to said substrate.

7. An artificial lawn comprising a mat according to claim 1; and infill material.

8. The artificial lawn of claim 7, wherein at least a portion of said infill material is dispersed throughout said artificial fibers onto said cushioning layer.

9. The artificial lawn of claim 8, comprising a mat wherein said cushioning layer comprises a substrate and an open web of inter-engaged continuously, crinkled filaments of resilient polymeric material forming an integrated structure, wherein at least a portion of said infill material is dispersed throughout said open web, and also in between said artificial fibers.

10. The artificial lawn according to claim 7, wherein the infill material is made of plastics, rubber material, or organic material.

11. The artificial lawn according to claim 7, having a force reduction (FR) in the range of 40% to 90%.

12. The artificial lawn according to claim 7, having a vertical deformation (VD) in the range of 4-11 mm.

13. The artificial lawn according to claim 7, having an energy restitution (ER) in the range of 10% to 80%.

14. A process for producing a mat according to claim 1, comprising (i) providing a cushioning layer and (ii) tufting artificial fibers through said cushioning layer, forming a tufted structure.

15. The process of claim 14, wherein said cushioning layer comprises a substrate and an open web of inter-engaged continuously, crinkled filaments, wherein said artificial fibers are tufted through said substrate and through said open web.
